(19) United States
(12) Patent Application Publication
(10) Pub. No.: US 2025/0141574 A1
(43) Pub. Date: May 1, 2025

(54) COMPUTERIZED SYSTEM, METHOD AND APPARATUS FOR AUTOMATIC VALIDATION OF WIFI SENSING APPLICATIONS

(71) Applicant: PLUME DESIGN, INC., Palo Alto, CA (US)

(72) Inventor: Damjan PEGAM, Polzela (SI)

(21) Appl. No.: 18/913,375

(22) Filed: Oct. 11, 2024

Related U.S. Application Data
(60) Provisional application No. 63/594,095, filed on Oct. 30, 2023.

(51) Int. Cl. H04B 17/391; H04B 17/318; H04B 17/382; H04W 24/10

(52) U.S. Cl. CPC H04B 17/3912; H04B 17/318; H04B 17/382; H04W 24/10

(57) ABSTRACT

Disclosed are systems and methods that provide a novel functional, computerized testing framework for testing and configuring WiFi sensing applications, devices and/or environments. WiFi sensing technology has shown remarkable potential in various fields, including object detection, indoor positioning, environmental monitoring, and more. The disclosed, innovative framework provides a comprehensive, technical solution for WiFi sensing technology by utilizing a suite of testing and configuration tools and methodologies to evaluate the performance and accuracy of WiFi sensing systems in various real-world scenarios. Through controlled experiments and data analysis, the disclosed framework can fine-tune devices and/or application for improved performance of WiFi sensing operations.

### CROSS REFERENCE TO RELATED APPLICATION

This patent application claims the benefit of U.S. Provisional Application No. 63/594,095, filed Oct. 30, 2023, which is incorporated by reference herein in its entirety.

### FIELD OF THE DISCLOSURE

The present disclosure is generally related to networking systems and methods, and more particularly, to a computerized framework for performing wireless fidelity (WiFi) sensing testing, validation and configuration based therefrom.

### BACKGROUND

Devices, particularly wireless fidelity (WiFi) devices, such as access point (AP) devices and client devices capable of being connected thereto, can be tested and configured prior to shipment.

### SUMMARY OF THE DISCLOSURE

According to some embodiments, the present disclosure provides novel components, configurations and implementations to WiFi sensing technology. As discussed herein, the disclosed apparatus, systems and methods provide a novel framework of utilizing wireless signals from Wi-Fi networks to detect and monitor various environmental conditions and objects. WiFi sensing capitalizes on the intrinsic properties of Wi-Fi signals, which can penetrate obstacles and reflect off surfaces, enabling the collection of valuable information about the surrounding environment.

In recent years, the proliferation of Wi-Fi networks has transformed the way users can communicate and access information. This ubiquitous technology has not only revolutionized connectivity but also paved the way for innovative applications beyond traditional networking. WiFi sensing represents one such groundbreaking application, encompassing a diverse range of use cases with profound implications for various industries.

Accordingly, WiFi sensing has emerged as a promising avenue for object detection, indoor positioning and real-time monitoring of environmental conditions. Through the analysis of Wi-Fi signal reflections, applications and devices executing WiFi sensing can detect the presence and movement of individuals and objects, making it valuable in contexts such as smart homes, healthcare and security systems, inter alia. Additionally, WiFi sensing has been employed in indoor positioning systems to provide accurate location data within buildings, a capability particularly significant in the era of smart cities and the Internet of Things (IoT). Moreover, WiFi sensing technology has shown promise in gesture recognition, where it can detect and interpret specific gestures or motions, creating interactive and intuitive user interfaces.

The need for energy-efficient solutions in buildings has prompted the application of WiFi sensing to optimize heating, cooling, and lighting systems based on occupancy data. Furthermore, WiFi sensing technology has demonstrated its potential in privacy-preserving vital sign monitoring, as it can detect subtle movements such as breathing and heart rate without physical contact, offering unobtrusive health monitoring possibilities.

Despite the potential of WiFi sensing technology, there is a need for comprehensive, efficient, and privacy-conscious implementations. This technology, while versatile and non-intrusive, raises concerns regarding privacy and security, as it can monitor individuals without their explicit consent. Therefore, it is crucial to develop WiFi sensing systems that prioritize robust privacy protection while ensuring the accurate collection and interpretation of environmental and object-related data. Indeed, as discussed herein, the disclosed framework can improve how WiFi sensing applications execute, which can include, but not be limited to, their accuracy, efficiency and case of use within larger systems (e.g., security systems, for example). Thus, the disclosed apparatus, systems and methods provide novel technological solutions to existing shortcomings by providing an innovative solution for WiFi sensing technology, inclusive of its testing, configurations and implementations.

According to some embodiments, a method is disclosed for performing WiFi sensing testing, validation and configuration based therefrom. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at a device to perform a method for performing WiFi sensing testing, validation and configuration based therefrom.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIGS. 1A-1C provide example configurations within which the systems and methods disclosed herein could be implemented according to some embodiments of the present disclosure;

FIG. 2 is a block diagram of functional components of an AP device according to some embodiments of the present disclosure;

FIG. 3 is a block diagram illustrating components of an exemplary system according to some embodiments of the present disclosure;

FIG. 4 illustrates an exemplary workflow according to some embodiments of the present disclosure;

FIG. 5 depicts an exemplary implementation of an architecture according to some embodiments of the present disclosure;

FIG. 6 depicts an exemplary implementation of an architecture according to some embodiments of the present disclosure; and

FIG. 7 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ different architectures or may be compliant or compatible with different protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

Certain embodiments and principles will be discussed in more detail with reference to the figures. As discussed herein, according to some embodiments, the disclosed apparatus, systems and methods provide a computerized framework for testing and configuring WiFi sensing applications, devices and/or environments. WiFi sensing technology has shown remarkable potential in various fields, including object detection, indoor positioning, environmental monitoring, and more. However, the successful deployment of WiFi sensing applications requires a rigorous approach to testing and configuration to ensure accuracy, reliability and privacy. The instant disclosure provides a comprehensive solution for this critical aspect of WiFi sensing technology.

According to some embodiments, as discussed in more detail below, disclosed is an innovative testing framework designed specifically for WiFi sensing, which can be utilized to test and configure WiFi sensing applications and/or devices. According to some embodiments, the disclosed framework encompasses a suite of testing tools and methodologies to evaluate the performance and accuracy of WiFi sensing systems in various real-world scenarios. In some embodiments, for example, the framework includes test scenarios that mimic common use cases, such as occupancy monitoring, vital sign detection, and gesture recognition, enabling thorough system evaluation. Through controlled experiments and data analysis, the system can be fine-tuned for optimal performance.

Moreover, accurate and efficient configuration is vital for the successful deployment of WiFi sensing applications and devices. According to some embodiments, the instant disclosure provides configuration functionality and/or operations that automates the process of fine-tuning WiFi sensing parameters. As discussed in more detail below, in some embodiments, by analyzing the data collected during the testing phase, the disclosed framework can intelligently adjust application and/or device configuration settings to adapt to the specific environment and application/device requirements. This, among other benefits, ensures that WiFi sensing devices/applications are optimized for accuracy and efficiency without requiring extensive manual adjustments.

Accordingly, as discussed in more detail below, the disclosed apparatus, systems and methods address the critical aspects of testing and configuring WiFi sensing applications via the disclosed, comprehensive testing framework, configuration optimization, and privacy protection measures that can ensure accurate, reliable and privacy-compliant operations. By simplifying system management through a user-friendly interface and implementation, the disclosed framework empowers users to harness the full potential of WiFi sensing technology in diverse applications.

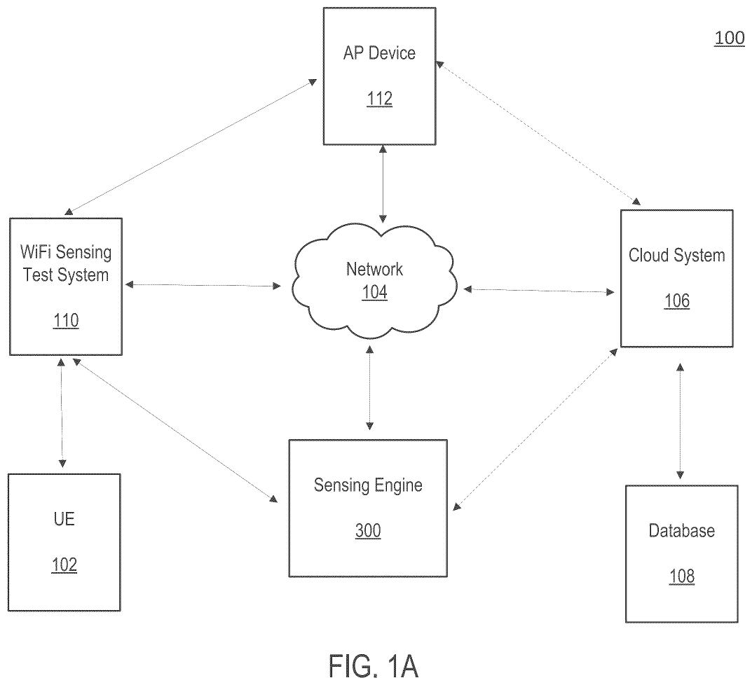

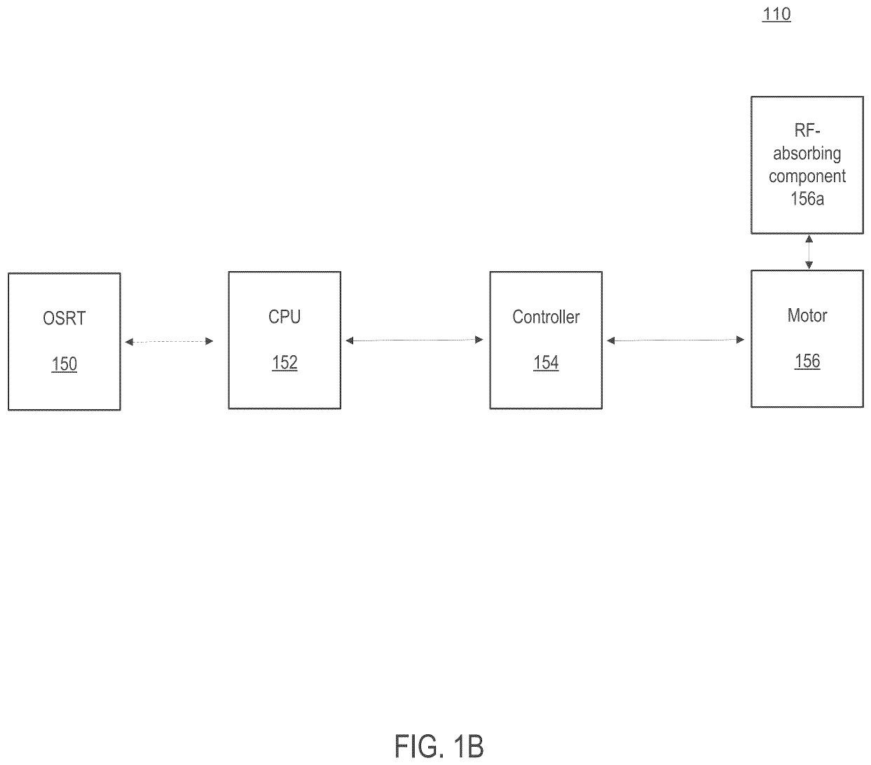

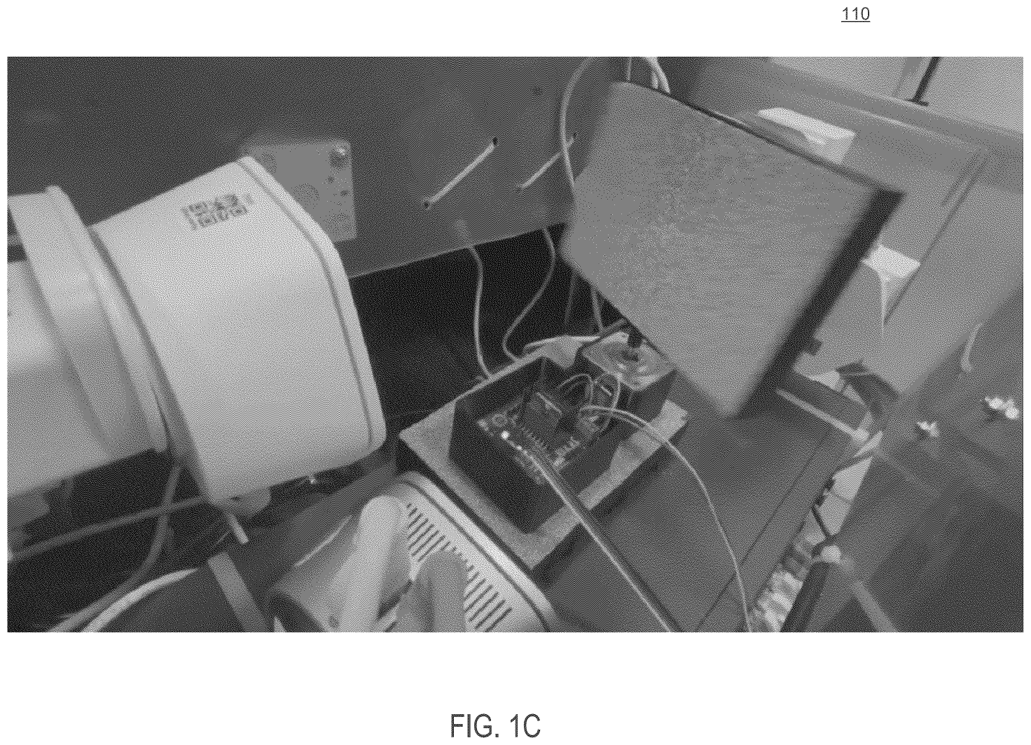

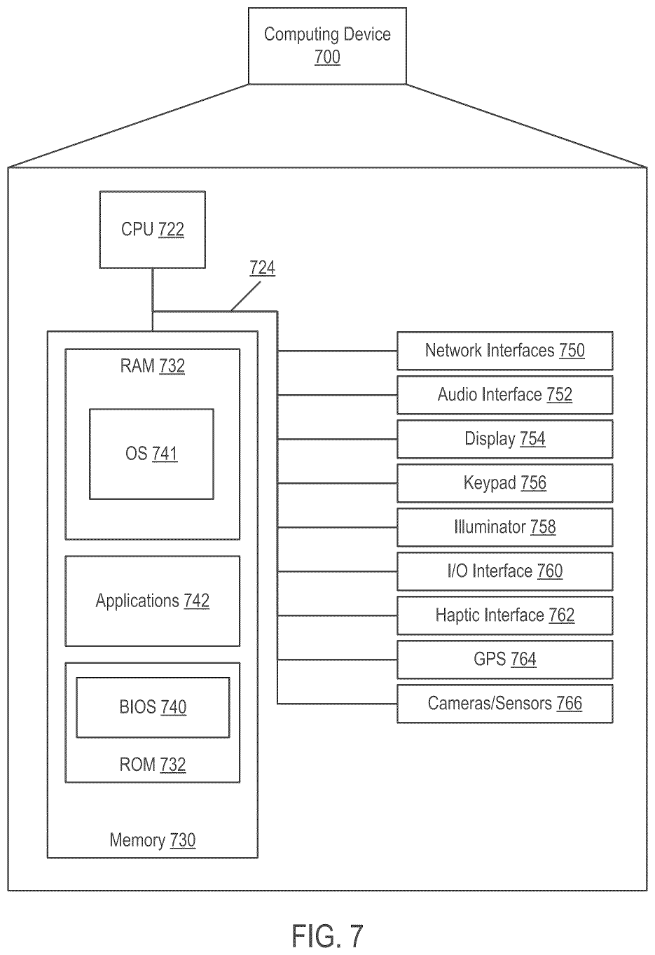

With reference to FIG. 1A, system 100 is depicted which includes user equipment (UE) 102 (e.g., a client device, as mentioned above and discussed below in relation to FIG. 7), access point (AP) device 112, network 104, cloud system 106, database 108, WiFi sensing test system 110 and sensing engine 300. It should be understood that while system 100 is depicted as including such components, it should not be construed as limiting, as one of ordinary skill in the art would readily understand that varying numbers of UEs, AP devices, testing systems, engines, peripheral devices, cloud systems, databases and networks can be utilized; however, for purposes of explanation, system 100 is discussed in relation to the example depiction in FIG. 1A.

According to some embodiments, UE 102 can be any type of device, such as, but not limited to, a mobile phone, tablet, laptop, sensor, IoT device, wearable device, autonomous machine, and any other device equipped with a cellular or wireless or wired transceiver.

In some embodiments, peripheral devices (not shown) can be connected to UE 102, and can be any type of peripheral device, such as, but not limited to, a wearable device (e.g., smart watch), printer, speaker, sensor, and the like. In some embodiments, a peripheral device can be any type of device that is connectable to UE 102 via any type of known or to be known pairing mechanism, including, but not limited to, WiFi, Bluetooth™, Bluetooth Low Energy (BLE), NFC, and the like.

According to some embodiments, AP device 112 is a device that creates and/or provides a wireless local area network (WLAN) for the location. According to some embodiments, the AP device 112 can be, but is not limited to, a router, switch, hub, gateway, extender and/or any other type of network hardware that can project a WiFi signal to a designated area. In some embodiments, UE 102 may be an AP device.

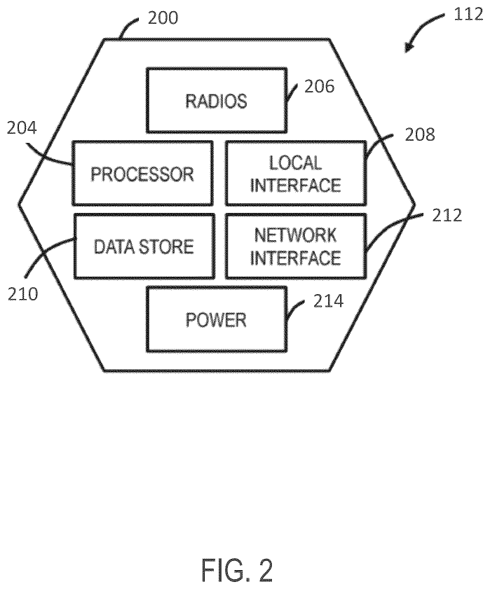

Turning to FIG. 2, depicted is an example AP device 112 and its corresponding functional components. AP device 112 can include, but is not limited to, a physical form factor 200, which contains a processor 204, one or more radios 206, a local interface 208, a data store 210, a network interface 212 and power 214. It should be understood by those of ordinary skill in the depicted AP device 112 is depicted in an oversimplified manner, and a practical embodiment may include additional components and suitably configured processing logic to support features described herein or known or conventional operating features that are not described in detail herein.

In some embodiments, the form factor 200 is a compact physical implementation where the AP device 112 directly plugs into an electrical socket and is physically supported by the electrical plug connected to the electrical socket.

In some embodiments, processor 204 is a hardware device for executing software instructions. Processor 204 can be any custom made or commercially available processor, a central processing unit (CPU), an auxiliary processor among several processors associated with a mobile device, a semiconductor-based microprocessor (in the form of a microchip or chip set), or generally any device for executing software instructions. When the AP device 112 is in operation, the processor 204 can be configured to execute software stored within memory or the data store 210, to communicate data to and from the memory or the data store 210, and to generally control operations of the AP device 112 pursuant to the software instructions. In some embodiments, the processor 204 may include a mobile-optimized processor such as optimized for power consumption and mobile applications.

In some embodiments, radios 206 can enable wireless communication in a distributed Wi-Fi system. Radios 206 can operate according to the IEEE 802.11 standard. In some embodiments, radios 206 can include address, control and/or data connections to enable appropriate communications of a Wi-Fi system. As described herein, AP device 112 includes one or more radios to support different links (e.g., backhaul links and client links). Such optimization can determine the configuration of the radios 206—such as, for example, bandwidth, channels, topology, and the like. In some embodiments, AP device 112 can support dual-band operation simultaneously operating 2.4 GHz (2.4G) and 5 GHz (5G) 2×2 Multiple Input, Multiple Output (MIMO) 802.11b/g/n/ac/ax radios capable of operating at 2.4 GHz, 5 GHz, and 6 GHz. Additionally, AP device 112 can be adapted to operate (e.g., send and receive signals) over Bluetooth, Wi-Fi, Cellular (Long-Term Evolution (LTE), 5G, and the like), Ultra-Wide Band (UWB), Matter, ZigBee, NFC, millimeter waves technologies (60 GHz radar), and others of the like. AP device 112 can further include antennas supporting a plurality of protocols at a plurality of frequencies for wireless communication.

In some embodiments, local interface 208 can be configured for local communication to AP device 112 and can be either a wired connection or wireless connection, such as Bluetooth or the like. Since AP device 112 can be configured via the cloud, an onboarding process may be required to first establish connectivity for a newly turned on AP device 112. In some embodiments, AP device 112 can also include the local interface 108 allowing connectivity to UE 102 for onboarding to a Wi-Fi network, such as through an app on the UE 102.

In some embodiments, data store 210 is used to store data, and can include any type of volatile memory elements (e.g., random access memory (RAM, such as DRAM, SRAM, SDRAM, and the like)), nonvolatile memory elements (e.g., ROM, hard drive, tape, CD-ROM, and the like), and combinations thereof. Moreover, data store 210 may incorporate electronic, magnetic, optical, and/or other types of storage media.

In some embodiments, network interface 212 provides wired connectivity to AP device 112. Network interface 112 may be used to enable AP device 112 to communicate to a modem/router. In some embodiments, network interface 212 can be used to provide local connectivity to a Wi-Fi client device or user device. In some embodiments, network interface 212 may include address, control, and/or data connections to enable appropriate communications on the network.

In some embodiments, processor 204 and the data store 210 can include software and/or firmware that controls the operation of AP device 112, data gathering and measurement control, data management, memory management, and communication and control interfaces. In some embodiments, processor 204 and the data store 210 may be configured to implement the various processes, algorithms, methods, techniques, and the like, as described herein.

Turning back to FIG. 1A, according to some embodiments, WiFi sensing test system 110 can be a specialized piece of equipment used to simulate and control various networking conditions in a controlled testing environment. According to some embodiments, WiFi sensing test system 110 can provide OpenSync Reference Testbed (OSRT) and/or Unified Standard Testbed (USTB) functionality so as to enable a unified, standard testbed, which can be used for testing and configuration within various types of network operating environments (e.g., at a location, mobile, and a varying number of UEs and/or AP devices connected thereto). As discussed herein, WiFi sensing test system 110 can enable the operational evaluation of the performance and behavior of WiFi devices under different network scenarios. WiFi sensing test system 110 can therefore operate as a “network emulator” and/or “network simulator.”

According to some embodiments, WiFi sensing test system 110 can provide features and/or functionalities for WiFi testing that include, but are not limited to, network scenario replication, traffic shaping, emulation of WiFi/wireless networks, protocol manipulation, interference generation, multiple user emulation, monitoring and reporting, automation and scripting support, and the like.

According to some embodiments, network scenario replication can involve WiFi sensing test system 110 replicating various real-world network conditions, such as latency, packet loss, jitter, bandwidth limitations, and the like, which can enable testing environments to mimic different types of network environments.

In some embodiments, traffic shaping can involve WiFi sensing test system 110 shaping the network traffic to simulate different network speeds and conditions. For example, this can assist in assessing how WiFi devices can perform under varying bandwidths. In some embodiments, WiFi sensing test system 110 can emulate and/or introduce the characteristics of a wireless communication into a testing environment. In some embodiments, protocol manipulation can involve WiFi sensing test system 110 to manipulate network protocols to simulate challenging situations and evaluate how WiFi devices respond to such scenarios.

In some embodiments, with regard to interference generation, WiFi testing can involve evaluating the device's performance in the presence of interference from other devices and/or neighboring networks. Accordingly, in some embodiments, WiFi sensing test system 110 can generate interference signals to replicate such scenarios.

In some embodiments, WiFi sensing test system 110 can monitor and report network conditions, and device performance metrics during testing, which can be utilized to automate the configuration of the network, device(s) providing the network and/or devices connected thereto.

Accordingly, WiFi sensing test system 110 can support automation and scripting capabilities to streamline testing procedures and enable repeatable test cases, which can be in-line with predefined testing profiles and/or scenarios. WiFi sensing test system 110 can integrate with other testing tools and frameworks, which can enable a scalable testing infrastructure. As provided herein, WiFi sensing test system 110 can provide functionality for identifying potential performance bottlenecks, vulnerabilities and areas for improvement, which can be leveraged to fine-tune the network in actual WiFi sensing deployments.

Turning to FIG. 1B, depicted is an example of WiFi sensing test system 110, and its configuration for performing a WiFi sensing test and subsequent application/device configuration. According to some embodiments, system 100 can include a CPU 152, controller 154, stepper motor 156 and RF-absorbing component 156a (or RF component), which is attached to motor 156. In some embodiments, OSRT component 150 can be optionally utilized to provide instructions and/or testing configurations for CPU 152.

According to some embodiments, the motor 156 is controlled by CPU 152 and controller 154, where in some embodiments, controller 154 can be embodied as engine 300 executing on and/or association with CPU 152. In some embodiments, CPU 152 can be a mini PC. According to some embodiments, as discussed below, system 110 can control the different speeds and duration of the stepper motor 156 that moves RF-absorbing component 156a. With that movement, system 110 can simulate physical movement and trigger sensing detection of WiFi signals.

In some embodiments, component 156a can be configured to RF-absorbing foam so as to detect and collect WiFi signal data, as discussed below. In some embodiments, component 156a can rotate clockwise, counter-clockwise, and can rotate/spin at predetermined and/or dynamically determined rates, speeds, frequencies, and the like, as discussed below.

According to some embodiments, RF-absorbing foam, also known as electromagnetic (EM) or radiofrequency-absorbing foam, is designed to attenuate or absorb electromagnetic radiation, including radiofrequency (RF) signals. There are various types of RF-absorbing foam, each with specific properties and applications. Thus, according to some embodiments, component 156a can be affixed with, but not be limited to, conductive foam, ferrite-loaded foam, pyramidal foam, wave-absorbing foam, low-dielectric constant foam, silicone-based foam, polyurethane foam, hybrid foam, and the like. For example, in some embodiments, the choice of RF-absorbing foam type depends on the specific application, the frequency range of the RF signals involved, and the desired performance characteristics. Whether it's for RF shielding, EMC testing, or interference reduction, selecting the appropriate RF-absorbing foam can be related to the desired electromagnetic attenuation and/or RF absorption.

According to some embodiments, CPU 152 can serve as the brain of the testing system 110, orchestrating the operation of the entire setup. CPU 152 can control the other hardware components and is responsible for data collection, analysis, and system optimization. In some embodiments, CPU 152 can work in connection with and/or based on instructions provided by OSRT 150. In some embodiments, CPU 152 can operate based on instructions executed via engine 300, as discussed infra.

In some embodiments, controller 154 interfaces with the CPU 152 and manages the movement of a stepper motor 156. In some embodiments, controller 154 can operate based on instructions executed via engine 300, as discussed infra. In some embodiments, controller 154 can translate commands from CPU 152 and/or engine 300 into precise motor movements, allowing for controlled object motion simulation.

In some embodiments, stepper motor 156 provides controlled and repeatable motion within the testing environment. Programmed to move at varying speeds and directions, motor 156 can emulate the movement of objects or individuals, enabling comprehensive testing of WiFi sensing systems. In some embodiments, component 156a, which includes RF-absorbing foam, discussed supra, can be utilized to collect WiFi signals and/or minimize external RF interference. In some embodiments, this can ensure that collected WiFi signal data is not unduly influenced by external factors.

Turning to FIG. 1C, depicted is a non-limiting depiction of the components of system 110 depicted in FIG. 1B. Accordingly, as depicted in FIGS. 1A-1C, system 110, via execution of engine 300, as discussed below, can provide implementations for testing and configuring WiFi sensing applications, such that accurate assessments and optimizations of WiFi-based object detection and tracking systems can be performed. As depicted in at least FIGS. 1B and 1C, (optionally) OSRT 150, CPU 152, controller 154, motor 156 and RF-absorbing component 156a can facilitate controlled testing and fine-tuning of WiFi sensing applications. Thus, system 110 can utilize a combination of hardware and software components to mimic real-world scenarios, collect data, and optimize the performance of WiFi sensing applications.

Turning back to FIG. 1A, in some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a smart home or network provider, which has associated network resources hosted on the internet or private network (e.g., network 104), which enables (via engine 300) the network management discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE 102, AP device 112, WiFi sensing test system 110, and the services and applications provided by cloud system 106 and/or sensing engine 300).

In some embodiments, for example, cloud system 106 can provide a private/proprietary management platform, whereby engine 300, discussed infra, corresponds to the novel functionality system 106 enables, hosts and provides to a network 104 and other devices/platforms operating thereon.

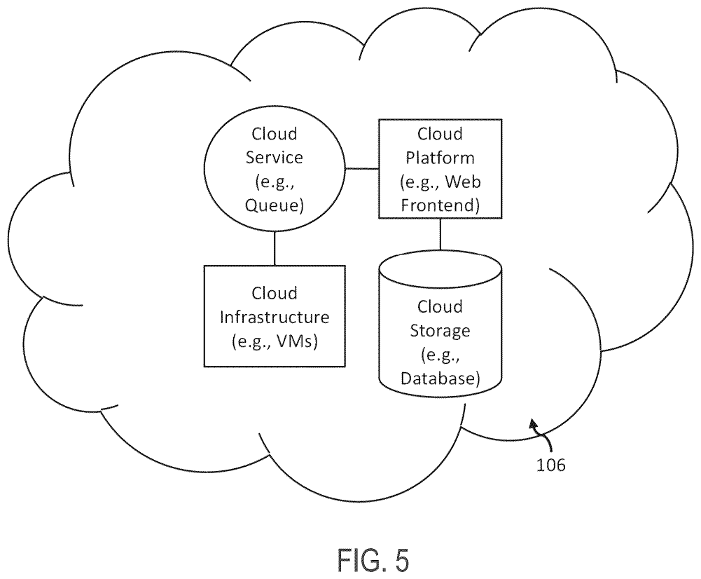

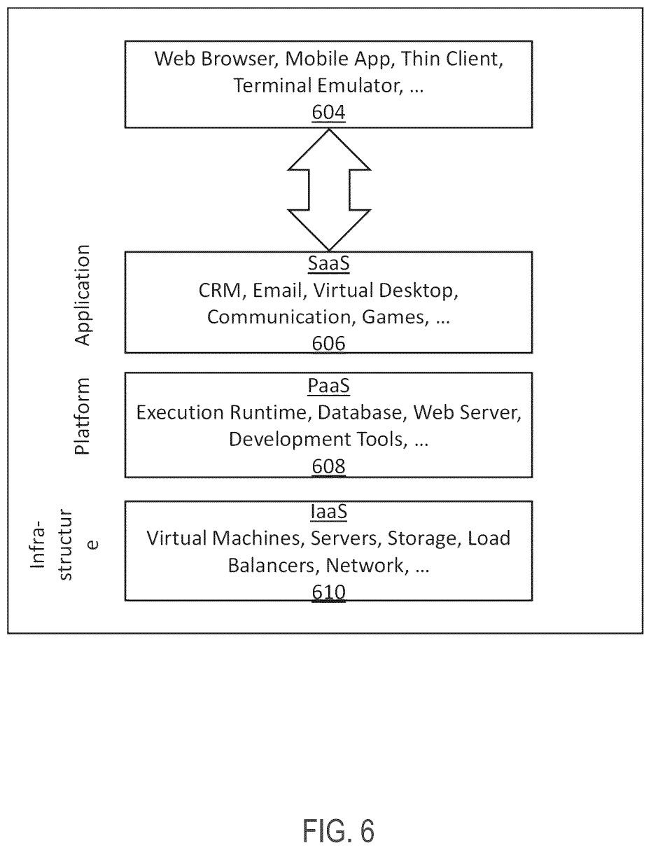

Turning to FIGS. 5 and 6, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure as a service (IaaS) 610, platform as a service (PaaS) 608, and/or software as a service (SaaS) 606 using a web browser, mobile app, thin client, terminal emulator or other endpoint 604. FIGS. 5 and 6 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, engine 300 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

Sensing engine 300, as discussed above and further below in more detail, can include components for the disclosed functionality. According to some embodiments, sensing engine 300 may be a special purpose machine or processor, and can be hosted by a device on network 104, within cloud system 106, on AP device 112, UE 102 and/or WiFi sensing test system 110. In some embodiments, engine 300 may be hosted by a server and/or set of servers associated with cloud system 106.

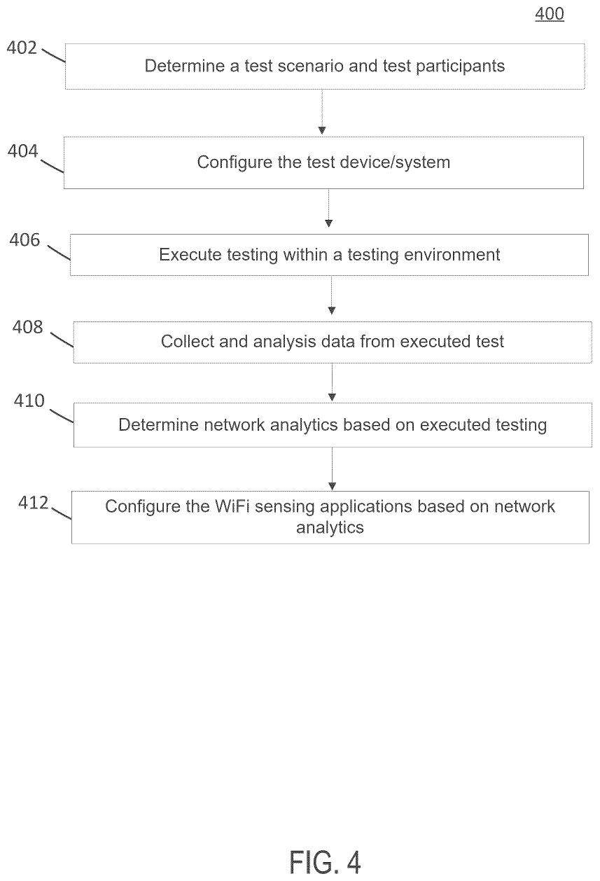

According to some embodiments, as discussed in more detail below, sensing engine 300 may be configured to implement and/or control a plurality of services and/or microservices, where each of the plurality of services/microservices are configured to execute a plurality of workflows associated with performing the disclosed network management. Non-limiting embodiments of such workflows are provided below in relation to at least FIG. 4.

According to some embodiments, as discussed above, sensing engine 300 may function as an application provided by cloud system 106. In some embodiments, engine 300 may function as an application installed on a server(s), network location and/or other type of network resource associated with system 106. In some embodiments, engine 300 may function as an application installed and/or executing on AP device 112, UE 102 and/or WiFi sensing test system 110. In some embodiments, such application may be a web-based application accessed by AP device 112, UE 102 and/or WiFi sensing test system 110 over network 104 from cloud system 106. In some embodiments, engine 300 may be configured and/or installed as an augmenting script, program or application (e.g., a plug-in or extension) to another application or program provided by cloud system 106 and/or executing on AP device 112, UE 102 and/or WiFi sensing test system 110.

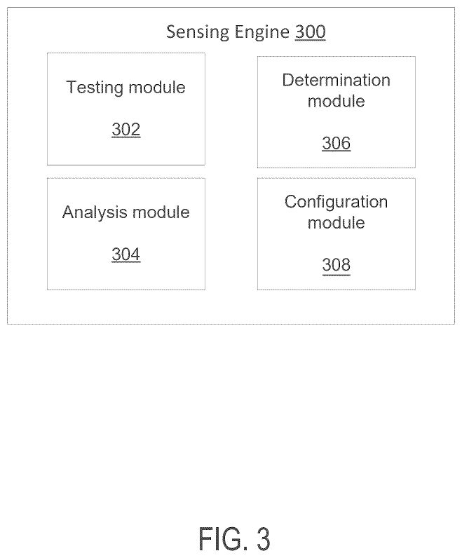

As illustrated in FIG. 3, according to some embodiments, sensing engine 300 includes testing module 302, analysis module 304, determination module 306 and configuration module 308. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 300 and each of its modules, and their role within embodiments of the present disclosure will be discussed below.

Turning to FIG. 4, Process 400 provides non-limiting example embodiments for the disclosed WiFi sensing testing, configuration and validation framework. As discussed herein, the disclosed processing via the steps of Process 400 enable engine 200 to operate to configure a device to be optimally configured to detect distinctive WiFi signals as a motion event, whereby reporting for a WiFi sensing application can be effectuated therefrom.

According to some embodiments, Steps 402 and 406 of Process 400 can be performed by testing module 302 of sensing engine 300; Steps 404 and 412 can be performed by configuration module 308; Step 408 can be performed by analysis module 304; and Step 410 can be performed by determination module 306.

According to some embodiments, Process 400 begins with Step 402 where engine 300 can determine a test scenario and test participants. As discussed above at least respective to FIGS. 1A-1C, the test participants can be WiFi sensing test system 110 (and the components included therein, as discussed in FIGS. 1B-1C, supra) and/or UE 102 and/or AP device 112.

According to some embodiments, the test scenario can correspond to the testing environment, which can correspond to a real-world environment (e.g., a security system deployed with a location—for example, a home, office, and/or other geographic area for where a security system can be configured thereto).

According to some embodiments, a test scenario can correspond to a controlled environment that is established to evaluate the performance and functionality of a WiFi sensing application. In some embodiments, such scenario/environment can represent a context in which the WiFi sensing application can be deployed, such as a smart home, healthcare facility, or industrial setting. The scenario involves multiple key characteristics that include, but are not limited to, diverse object movement, obstacles and interference, privacy and security considerations, environmental factors, multiple scenarios, and the like.

According to some embodiments, a test scenario can include various objects or individuals moving within the space, simulating real-world situations. This diverse movement may include people walking, sitting, or engaging in activities, and objects being repositioned or manipulated, enabling the assessment of the system's tracking and detection capabilities.

In some embodiments, the presence of obstacles, such as, for example, walls, furniture, and other structures within the test area mimics real-world conditions, affecting the propagation of WiFi signals. This accounts for signal reflection and interference, allowing the demonstration of the ability for the testing to be deployed within various forms of complex environments.

In some embodiments, the test scenario can include characteristics related to, but not limited to, position of system 110, position of UE and/or AP device, size of RF foam (thickness, width and/or length), type of RF foam, color of RF foam, rotation frequency, rate and/or duration of RF foam, and the like.

In some embodiments, privacy concerns can be addressed via a test scenario by ensuring that engine 300 adheres to privacy regulations and does not capture or transmit personally identifiable information. Security measures are implemented to protect data from unauthorized access and mitigate potential risks.

In some embodiments, factors including, but not limited to, lighting, temperature, and humidity can be considered, as they can influence the testing's performance. Testing under various environmental conditions helps assess the robustness and adaptability of the sensing applications.

And, in some embodiments, a test scenario can be designed to cover a range of scenarios, such as occupancy monitoring, vital sign detection, or gesture recognition, inter alia, or some combination thereof. This comprehensive testing provides insights into the suitability for diverse applications and use cases.

Accordingly, in some embodiments, such testing scenario can be based on and/or configured with specified WiFi parameters, which can include, but are not limited to, frequency, amplitude (signal strength), wavelength, propagation, modulation, channel bandwidth, channel overlap, interference, data rate, latency, multipath fading, security and the like.

Thus, in Step 402, the test scenario can be a recreation of real-world conditions and factors, which allows for a thorough evaluation of the WiFi sensing application's performance, ensuring that it functions effectively and reliably within the intended context of deployment.

In Step 404, engine 200 can configure the WiFi sensing test system 110 according to the test scenario. According to some embodiments, for example, with reference to FIG. 1B, CPU 152 can be configured to provide instructions to controller 154, such that stepper motor 156 operates at a frequency of X, thereby causing RF-absorbing component 156 rotates clock-wise at such frequency for a duration of Y seconds. Thus, the test scenario for UE 102, for example, can be initiated via system 110 be configured to execute accordingly.

In Step 406, the testing within a testing environment can be executed. Thus, for example, a set or plurality of devices, which can be UEs, AP devices and/or some combination thereof, can have their WiFi sensing applications and/or functionalities tested therein via operation of the configured testing scenario (as per Step 404).

In Step 408, data from the executed test can be collected and analyzed. According to some embodiments, during the testing, data is collected on WiFi signal strength, phase, and other relevant parameters. This data is then analyzed to assess the system's accuracy in detecting and tracking objects or individuals. Any anomalies or limitations are documented for further refinement.

According to some embodiments, such analysis can be performed via implementation/execution of any type of known or to be known computational analysis technique, algorithm, mechanism or technology. In some embodiments, engine 300 may include a specific trained artificial intelligence/machine learning model (AI/ML), a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 300 may be configured to utilize one or more AI/ML techniques chosen from, but not limited to, computer vision, feature vector analysis, decision trees, boosting, support-vector machines, neural networks, nearest neighbor algorithms, Naive Bayes, bagging, random forests, logistic regression, and the like.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
e. apply the trained model to process the newly-received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

In Step 410, based on such computational analysis, engine 300 can determine network analytics based on the network testing. Such analytics can include, but are not limited to, measurements of frequency, amplitude (signal strength), wavelength, propagation, modulation, channel bandwidth, channel overlap, interference, data rate, latency, multipath fading, security and the like for the UEs and/or AP devices. According to some embodiments, such measurement data can be stored in database 108, as discussed above.

And, in Step 412, WiFi sensing applications utilized, integrated and/or implemented by UEs and/or AP devices, and/or the WiFi functionalities integrated in such devices, can be configured, modified and/or adjusted to ensure certain network parameters, attributes or characteristics are within an acceptable range or comply with certain regulations, rules or parameters for a properly configured and operating network functionality for WiFi sensing applications. In some embodiments, engine 300 can analyze the network analytics, and should certain motion detection events be non-detected, ignored or mis-recognized for particular testing scenarios, engine 300 can cause such modifications and configurations based therefrom. Thus, should particular events, and/or network parameters, attributes or characteristics (e.g., latency, for example) be at or a below threshold levels, such parameters and/or components of the UE/AP devices can be configured/modified to ensure such network parameters, attributes or characteristics are within an acceptable range so that certain motion events are detectable.

As such, as in Step 412, engine 300 can cause the performance of system optimization, such that configuration parameters of the WiFi sensing application can be fine-tuned based on the analysis and determination (in Steps 408 and 410), thereby optimizing the WiFi sensing application being tested for improved accuracy, reliability, and responsiveness in the real-world environment. In some embodiments, such configuration can be based on the compilation of executable instructions that, upon installation, and/or execution in relation to a WiFi sensing application/device, such application/device can be modified to alter its operation to improve detection of motion respective to the parameters of the testing scenario.

By way of non-limiting example, according to some embodiments in line with the performance of Steps 402-412 of Process 400, engine 300 can effectuate operation of the following steps:

Controlled Movement Simulation: The CPU 152 and controller 154 collaborate to initiate and manage the precise motion of the stepper motor 156. The motor's movement replicates the motion patterns of objects or individuals via movement of component 156a.

Data Collection: While the stepper motor 156 is in motion, engine 300 can collect data related to WiFi signal strength, phase, and other relevant parameters.

Data Analysis: Collected data can be processed and analyzed by the CPU 152 to evaluate the WiFi sensing application's performance (e.g., the ability to detect and track movement is assessed).

Configuration Optimization: Based on the analysis, the CPU 152 can adjust configuration parameters of the WiFi sensing test system 110 (and/or UE/AP device being tested). This fine-tuning provides optimization for accuracy and reliability for future tests.

In some embodiments, the testing process (of Process 400 (e.g., Step 406), inter alia) can be repeated under different scenarios, including various object movement patterns and environmental conditions. Data can be collected to validate the findings and configurations from such tests in a similar manner. Indeed, in some embodiments, engine 300 can implement privacy protection measures, which can additionally be evaluated to ensure that data privacy is maintained during testing.

In some embodiments, results of the tests can be documented in comprehensive reports, including observed limitations and recommendations for improvements. Such reports can be provided to users, and/or network, service and/or third party providers.

As such, the apparatus, systems and methods for testing WiFi sensing applications, as described herein, provides a systematic and controlled approach to evaluate and optimize the performance of WiFi-based object detection and tracking systems. As discussed above, in some embodiments, the use of a CPU 152, controller 154, stepper motor 156 and RF-absorbing component 156a can enable WiFi sensing applications to function accurately, reliably and securely in diverse real-world environments. The disclosed operational framework can facilitate the identification and mitigation of potential challenges, ultimately enhancing a WiFi sensing application's overall effectiveness.

FIG. 7 is a schematic diagram illustrating a client device showing an example embodiment of a client device that may be used within the present disclosure. Client device 700 may include many more or less components than those shown in FIG. 7. However, the components shown are sufficient to disclose an illustrative embodiment for implementing the present disclosure. Client device 700 may represent, for example, UE 102 discussed above at least in relation to FIG. 1.

As shown in the figure, in some embodiments, Client device 700 includes a processing unit (CPU) 722 in communication with a mass memory 730 via a bus 724. Client device 700 also includes a power supply 726, one or more network interfaces 750, an audio interface 752, a display 754, a keypad 756, an illuminator 758, an input/output interface 760, a haptic interface 762, an optional global positioning systems (GPS) receiver 764 and a camera(s) or other optical, thermal or electromagnetic sensors 766. Device 700 can include one camera/sensor 766, or a plurality of cameras/sensors 766, as understood by those of skill in the art. Power supply 726 provides power to Client device 700.

Client device 700 may optionally communicate with a base station (not shown), or directly with another computing device. In some embodiments, network interface 750 is sometimes known as a transceiver, transceiving device, or network interface card (NIC).

Audio interface 752 is arranged to produce and receive audio signals such as the sound of a human voice in some embodiments. Display 754 may be a liquid crystal display (LCD), gas plasma, light emitting diode (LED), or any other type of display used with a computing device. Display 754 may also include a touch sensitive screen arranged to receive input from an object such as a stylus or a digit from a human hand.

Keypad 756 may include any input device arranged to receive input from a user. Illuminator 758 may provide a status indication and/or provide light.

Client device 700 also includes input/output interface 760 for communicating with external. Input/output interface 760 can utilize one or more communication technologies, such as USB, infrared, Bluetooth™, or the like in some embodiments. Haptic interface 762 is arranged to provide tactile feedback to a user of the client device.

Optional GPS transceiver 764 can determine the physical coordinates of Client device 700 on the surface of the Earth, which typically outputs a location as latitude and longitude values. GPS transceiver 764 can also employ other geo-positioning mechanisms, including, but not limited to, triangulation, assisted GPS (AGPS), E-OTD, CI, SAI, ETA, BSS or the like, to further determine the physical location of client device 700 on the surface of the Earth. In one embodiment, however, Client device 700 may through other components, provide other information that may be employed to determine a physical location of the device, including for example, a MAC address, Internet Protocol (IP) address, or the like.

Mass memory 730 includes a RAM 732, a ROM 734, and other storage means. Mass memory 730 illustrates another example of computer storage media for storage of information such as computer readable instructions, data structures, program modules or other data. Mass memory 730 stores a basic input/output system (“BIOS”) 740 for controlling low-level operation of Client device 700. The mass memory also stores an operating system 741 for controlling the operation of Client device 700.

Memory 730 further includes one or more data stores, which can be utilized by Client device 700 to store, among other things, applications 742 and/or other information or data. For example, data stores may be employed to store information that describes various capabilities of Client device 700. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 700.

Applications 742 may include computer executable instructions which, when executed by Client device 700, transmit, receive, and/or otherwise process audio, video, images, and enable telecommunication with a server and/or another user of another client device. Applications 742 may further include a client that is configured to send, to receive, and/or to otherwise process gaming, goods/services and/or other forms of data, messages and content hosted and provided by the platform associated with engine 300 and its affiliates.

According to some embodiments, certain aspects of the instant disclosure can be embodied via functionality discussed herein, as disclosed supra. According to some embodiments, some non-limiting aspects can include, but are not limited to the below method aspects, which can additionally be embodied as system, apparatus and/or device functionality:

Aspect 1. A method comprising:
identifying, by a wireless fidelity (WiFi) test system, a test scenario, the test scenario comprising parameters corresponding to a real-world WiFi sensing environment, the test scenario including at least one user equipment (UE);
executing, by the WiFi test system, a WiFi sensing operation via the test scenario, the execution comprising the generation and collection of network data within the real-world WiFi sensing environment;
analyzing, by the WiFi test system, the collected network data;
determining, by the WiFi test system, network analytics based on the executed WiFi sensing operation, the network analytics comprising an indication of an effectiveness of the WiFi operation within the test scenario; and
configuring, by the WiFi test system, the at least one UE based on the determined analytics, the configuration comprising controlling a WiFi sensing application associated with the UE.

Aspect 2. The method of aspect 1, wherein the control of the WiFi sensing application comprises modifying the configuration of the WiFi sensing application to improve a manner the UE can perform WiFi sensing operations, the improvement being according to a threshold.

Aspect 3. The method of aspect 1, wherein the WiFi test system comprises a central processing unit (CPU), controller, stepper motor and radio frequency (RF) component.

Aspect 4. The method of aspect 3, further comprising:
communicating instructions from the CPU to the controller, the instructions corresponding to the test scenario and the WiFi sensing operation;
activating, via the controller, according to the instructions, the stepper motor; and
causing, via the activation of the stepper motor, the RF component to rotate, the rotation of the RF component being at a frequency and according to a duration defined by the instructions.

Aspect 5. The method of aspect 4, wherein the execution of the WiFi sensing application is based on the communicated instructions.

Aspect 6. The method of aspect 3, wherein the RF component comprises RF foam affixed thereto.

Aspect 7. The method of aspect 3, wherein the WiFi test system further comprises an OpenSync Reference Testbed (OSRT), wherein the execution of the WiFi sensing operation is based on OSRT functionality.

Aspect 8. The method of aspect 1, wherein the test scenario comprises a plurality of UEs.

Aspect 9. The method of aspect 1, wherein the UE is at least one of a user device and access point (AP) device.

Aspect 10. The method of aspect 1, wherein the test scenario parameters comprise at least one of frequency, amplitude (signal strength), wavelength, propagation, modulation, channel bandwidth, channel overlap, interference, data rate, latency, multipath fading and security.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, API, instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, shell, bash, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
identifying, by a wireless fidelity (WiFi) test system, a test scenario, the test scenario comprising parameters corresponding to a real-world WiFi sensing environment, the test scenario including at least one user equipment (UE);
executing, by the WiFi test system, a WiFi sensing operation via the test scenario, the execution comprising the generation and collection of network data within the real-world WiFi sensing environment;
analyzing, by the WiFi test system, the collected network data;
determining, by the WiFi test system, network analytics based on the executed WiFi sensing operation, the network analytics comprising an indication of an effectiveness of the WiFi operation within the test scenario; and
configuring, by the WiFi test system, the at least one UE based on the determined analytics, the configuration comprising controlling a WiFi sensing application associated with the UE.

2. The method of claim 1, wherein the control of the WiFi sensing application comprises modifying the configuration of the WiFi sensing application to improve a manner the UE can perform WiFi sensing operations, the improvement being according to a threshold.

3. The method of claim 1, wherein the WiFi test system comprises a central processing unit (CPU), controller, stepper motor and radio frequency (RF) component.

4. The method of claim 3, further comprising:
communicating instructions from the CPU to the controller, the instructions corresponding to the test scenario and the WiFi sensing operation;
activating, via the controller, according to the instructions, the stepper motor; and
causing, via the activation of the stepper motor, the RF component to rotate, the rotation of the RF component being at a frequency and according to a duration defined by the instructions.

5. The method of claim 4, wherein the execution of the WiFi sensing application is based on the communicated instructions.

6. The method of claim 3, wherein the RF component comprises RF foam affixed thereto.

7. The method of claim 3, wherein the WiFi test system further comprises an OpenSync Reference Testbed (OSRT), wherein the execution of the WiFi sensing operation is based on OSRT functionality.

8. The method of claim 1, wherein the test scenario comprises a plurality of UEs.

9. The method of claim 1, wherein the UE is at least one of a user device and access point (AP) device.

10. The method of claim 1, wherein the test scenario parameters comprise at least one of frequency, amplitude (signal strength), wavelength, propagation, modulation, channel bandwidth, channel overlap, interference, data rate, latency, multipath fading and security.

11. A non-transitory computer-readable storage medium tangibly encoded with computer-executable instructions that when executed by a wireless fidelity (WiFi) test system, perform a method comprising:
identifying, by the WiFi test system, a test scenario, the test scenario comprising parameters corresponding to a real-world WiFi sensing environment, the test scenario including at least one user equipment (UE);
executing, by the WiFi test system, a WiFi sensing operation via the test scenario, the execution comprising the generation and collection of network data within the real-world WiFi sensing environment;
analyzing, by the WiFi test system, the collected network data;
determining, by the WiFi test system, network analytics based on the executed WiFi sensing operation, the network analytics comprising an indication of an effectiveness of the WiFi operation within the test scenario; and
configuring, by the WiFi test system, the at least one UE based on the determined analytics, the configuration comprising controlling a WiFi sensing application associated with the UE.

12. The non-transitory computer-readable storage medium of claim 11, wherein the control of the WiFi sensing application comprises modifying the configuration of the WiFi sensing application to improve a manner the UE can perform WiFi sensing operations, the improvement being according to a threshold.

13. The non-transitory computer-readable storage medium of claim 11, wherein the WiFi test system comprises a central processing unit (CPU), controller, stepper motor and radio frequency (RF) component, wherein the RF component comprises RF foam affixed thereto.

14. The non-transitory computer-readable storage medium of claim 13, further comprising:
communicating instructions from the CPU to the controller, the instructions corresponding to the test scenario and the WiFi sensing operation;
activating, via the controller, according to the instructions, the stepper motor; and
causing, via the activation of the stepper motor, the RF component to rotate, the rotation of the RF component being at a frequency and according to a duration defined by the instructions, wherein the execution of the WiFi sensing application is based on the communicated instructions.

15. The non-transitory computer-readable storage medium of claim 14, wherein the WiFi test system further comprises an OpenSync Reference Testbed (OSRT), wherein the execution of the WiFi sensing operation is based on OSRT functionality.

16. The non-transitory computer-readable storage medium of claim 11, wherein the test scenario comprises a plurality of UEs.

17. The non-transitory computer-readable storage medium of claim 11, wherein the UE is at least one of a user device and access point (AP) device.

18. An apparatus comprising:
a central processing unit (CPU), the CPU configured to communicate instructions to a controller;
the controller configured to receive the instructions and cause a stepper motor to operate according to a test scenario, the test scenario corresponding to a real-world wireless fidelity (WiFi) sensing operational environment;
the stepper motor executing according to the test scenario, the execution causing a radio frequency (RF) component connected to the stepper motor to rotate at a frequency and for a duration defined by the test scenario,
wherein the CPU collects network data from the execution of the test scenario and configures a WiFi sensing application based on analysis of the collected network data.

19. The apparatus of claim 18, further comprising:
an OpenSync Reference Testbed (OSRT), wherein the execution of the WiFi sensing operation is based on OSRT functionality.

20. The apparatus of claim 18, wherein the RF component comprises RF foam affixed thereto.
